(19) United States
(12) Patent Application Publication
(10) Pub. No.: US 2005/0047381 A1
(43) Pub. Date: Mar. 3, 2005

(54) System and method for a topology map related to access point usage in a wireless network

(75) Inventors: Gajendra Shukla, Sunnyvale, CA (US); Daniel Yun-Chak Wong, San Jose, CA (US); Hilton Hong, San Jose, CA (US)

Correspondence Address: Robert E. Krebs;Thelen Reid & Priest, LLP, P.O. Box 640640-0640, San Jose, CA, 95164-0640, US

(73) Assignee: Proxim Corporation, a Delaware Corporation

(21) Appl. No.: 10/765,558

(22) Filed: Jan. 26, 2004

Related U.S. Application Data
(60) Provisional application No. 60/443,107, filed on Jan. 27, 2003.

(51) Int. Cl. H04Q 7/00; G01S 13/08; H04Q 7/24

(52) U.S. Cl. 370/338; 342/126

(57) ABSTRACT

A method for wirelessly transmitting data under a wireless protocol is contemplated. An access point topology map is constructed or input. The topology map relates access points that have overlapping coverage areas, and thus, are prone to have remote devices travel between them. The relationships are used to send session parameters regarding a particular wireless device to the access points or gateways that border the zone in which the particular device is presently in. In this manner, information regarding the particular wireless device and open sessions may be present at such gateways or access points if and when the wireless device enters the zone that the gateway or access point is responsible for.

### CROSS-REFERENCE TO RELATED APPLICATION

This application claims priority based on provisional application Ser. No. 60/443,107 entitled “SYSTEM AND METHOD FOR A TOPOLOGY MAP RELATED TO ACCESS POINT USAGE IN A WIRELESS NETWORK” by Hilton Hung, filed on Jan. 27, 2003.

FIELD OF THE INVENTION

The present invention relates to a wireless communication system. More particularly, the present invention is related to balancing load traffic to and from access point in a wireless data transfer.

### BACKGROUND

In some wireless networks, an access point (AP) can be coupled to a variety of wireless network devices. Further, the access point can be wirelessly coupled to another access point in a bridging fashion. Typically, when a wireless network device moves outside the range of a first AP, the first access point dissociates itself from the wireless network device. When the wireless network device moves back into range of another AP, the wireless network device associates with that second AP.

In another case, two access point devices can have an overlapping zone. If an access point is only within range of a first access point of the pair, the wireless network device associates with that first AP. When the wireless network device moves into the overlapping zone, typically the wireless network device stays associated with the first AP. In some implementations, the access point devices may turn the contact over to the second access point for load distribution reasons.

However, when the wireless network device moves directly into the zone of the second access point without a turnover from the first access point to the second AP, the wireless network device must reestablish the communication with an attached network. Typically, some of the actions involved in such a turnover include establishing contact with the second AP, reauthorization, and rebroadcast to the rest of the network the particular details involved with the ability to reach the mobile wireless network device through the second AP.

As such, such a transition may disrupt the flow of information to and from the wireless network device. The turnover from the first to the second involves duplicative effort and leads to disruption in communication.

### SUMMARY

A method for wirelessly transmitting data under a wireless protocol is contemplated. An access point topology map is constructed or input. The topology map relates access points that have overlapping coverage areas, and thus, are prone to have remote devices travel between them. The relationships are used to send session parameters regarding a particular wireless device to the access points or gateways that border the zone in which the particular device is presently in. In this manner, information regarding the particular wireless device and open sessions may be present at such gateways or access points if and when the wireless device enters the zone that the gateway or access point is responsible for.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 is a network diagram of a wireless network with an access point topology map, according to the invention.

FIG. 2 is a diagram detailing an exemplary embodiment of the topology information of FIG. 1.

### DETAILED DESCRIPTION

Embodiments of the present invention are described herein in the context of a System And Method For A Topology Map Related To Access Point Usage In A Wireless Network. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of digital systems, including hardware, software, or any combination thereof. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

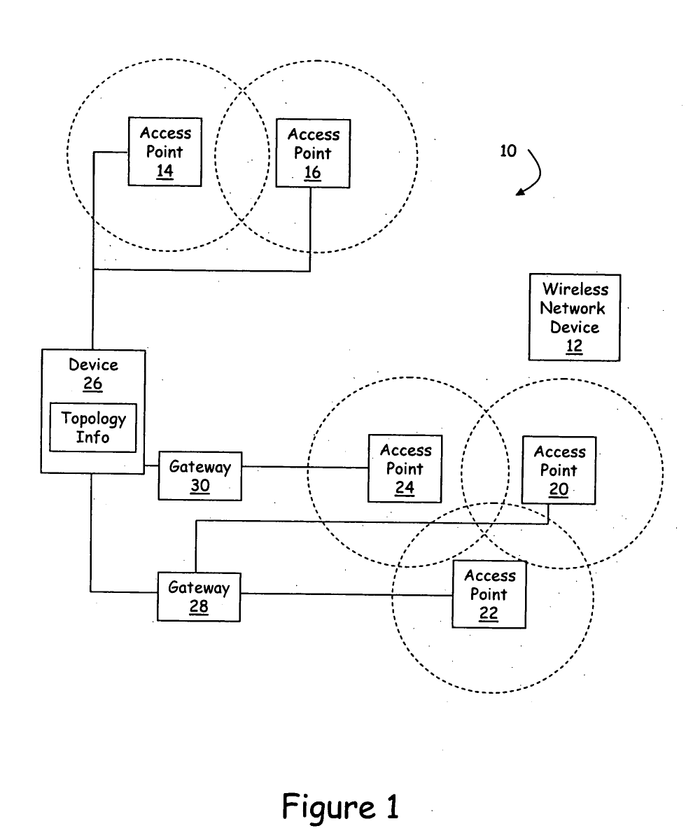

FIG. 1 is a network diagram of a wireless network with an access point topology map, according to the invention. In this case, wireless network 10 contains a wireless network device 12, access points 14, 16, 20, 22, and 24. The access points 14, 16, 20, 22, and 24 are coupled to a wired network 18. The zones of access points 20, 22, and 24 overlap to at least some extent.

The wireless protocol in the described example is one running under the 802.11 protocol. However, this specification should be read to include any wireless protocol implementing the ability to access mobile network devices.

At some time, the wireless network device 12 comes into contact with the access point 20. The wireless network device 12 and the access point 20 perform all the interactions necessary for the wireless network device 12 to communicate on the network 10.

At some level, a device contains access point topology relationship data. In FIG. 1, this topology relationship is contained in a device 26. The device 26 makes the access point topology information available to all devices on the network 10. It should be noted that the device 26 is any device capable of storing and transmitting the topology information to other points on the network 10. The device 26 can be, for example, an attached computer, router, server, or gateway, to name a few.

The access point topology relationship data is disseminated to the devices in the network. Accordingly, the various devices coupled to the network, including those responsible for administering the access points 20, 22, and 24 know the overlapping relationship of the access points 20, 22, and 24. In this example, the access points 20 and 22 share a common server or router 28, while the access point is coupled to a different server or router 30.

In this manner, the information available on the operational characteristics and parameters of the state of the wireless network device 12, including authorization information to the network, is disseminated to the gateway 28, the gateway 30, the access point 24, the access point 20, and the access point 22. Accordingly, since the wireless network device 12 initiated the session at the access point 24, the topology information allows the network to disseminate such information to any device that may have contact with the wireless network device 12 as it moves about. Since the access point 22 and the access point 20 overlap with the zone covered by the access point 24, the information on the session or sessions occurring on or that are associated with the wireless network device 12, or information on authorization or the like is promulgated to the access point 22 and the access point 20. Since the access point 22 is coupled to a different device on the wired network than the access point 24, namely gateway 28, such information is made available to the gateway 30 as well.

In this manner, should the wireless network device 12 move into a different zone of coverage, the move may occur in a seamless manner. This is since the information associated with the wireless network device is already there. Accordingly, the move into a different coverage area does not entail duplicative action or reauthorization steps.

It should be noted that any geometry of network may be used with the topology map. Further, the gateways 28 and 30 may also be replaced by wireless devices themselves.

The topology information may be derived by various methods. A network administrator may input the topology information. Or, the traffic patterns may be monitored and the topology may be derived by the traffic data itself. Additionally, the traffic data may be used in a probabilistic manner as well.

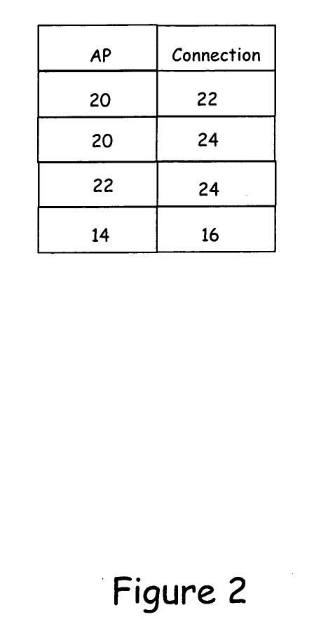

FIG. 2 is a diagram detailing an exemplary embodiment of the topology information of FIG. 1. The entries allow the overlapping areas to be defined on an access point basis in this embodiment. However, it should be noted that this is not the only manner in which the topology information may be stored and used in the context of this specification.

In the example of FIG. 2, assume that a wireless network device first initiates contact with the access point 24. In this manner, the appropriate information is passed to access point 22, as well as the gateway 28 that services the access point 22.

The information associated with the wireless network device 12 is also forwarded to the access point 20. Of course, the relationships of the various access point units and the devices that operate with them can be stored and used to promote seamless connections for mobile devices that access them, as shown in FIG. 2.

The topology relationships may be input by an administrator, or derived from usage of the network itself. In terms of deriving the relationships, the network is adapted to track the wireless devices. When the wireless device changes zones, a record of the origination and destination zone may be recorded. In this manner, the proximity of the zones may be derived simply by the record of the devices changing zones over time.

This concept can be extended to marking relationships where zones do not overlap, but are in proximity. In this case, the difference in time between the contact in one zone and in another may be used to determine is zones are close, but not overlapping. This relationship may also be used much as described above, since the proximity of the zone may be used to allow proximate access points and gateways that are not overlapping to receive the same type of information as described above.

Thus, a System And Method For A Topology Map Related To Access Point Usage In A Wireless Network is described and illustrated. Those skilled in the art will recognize that many modifications and variations of the present invention are possible without departing from the invention. Of course, the various features depicted in each of the Figures and the accompanying text may be combined together. Accordingly, it should be clearly understood that the present invention is not intended to be limited by the particular features specifically described and illustrated in the drawings, but the concept of the present invention is to be measured by the scope of the appended claims. It should be understood that various changes, substitutions, and alterations could be made hereto without departing from the spirit and scope of the invention as described by the appended claims that follow.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

1. A method of tracking a wireless device in a wireless network, the network having a plurality of gateways and each gateway coupled to at least one access point, the wireless device associated with a first access point, the method comprising:
associating the first access point and a second access point together when the first access point and the second access point have an overlapping coverage areas; and
transferring information associated with the wireless device to the second access point.

2. A method of tracking a wireless device in a wireless network, the network having a plurality of gateways and each gateway coupled to at least one access point, the wireless device associated with a first access point, the method comprising:
associating the first access point and a gateway coupled to the second access point together when the first access point and the second access point have an overlapping coverage areas; and
transferring information associated with the wireless device to the second access point.
